(19) United States
(12) Patent Application Publication
(10) Pub. No.: US 2016/0004526 A1
(43) Pub. Date: Jan. 7, 2016

(54) BRIDGE MODULE FOR UPDATING BASIC INPUT/OUTPUT SYSTEM AND UPDATING METHOD THEREOF

(71) Applicant: MSI COMPUTER(SHENZHEN) CO., LTD., Shenzhen City (CN)

(72) Inventors: Pang-Wei HSU, New Taipei City (TW); Yuh-Hann LEE, New Taipei City (TW); Wei-Ping SUNG, New Taipei City (TW); Yu-Cheng WU, New Taipei City (TW)

(21) Appl. No.: 14/490,265

(22) Filed: Sep. 18, 2014

(30) Foreign Application Priority Data
Jul. 1, 2014 (TW) 103122637

(51) Int. Cl. G06F 9/445; G06F 1/26

(52) U.S. Cl. CPC G06F 8/65; G06F 1/26

(57) ABSTRACT

A bridge module for updating basic input/output system (BIOS) includes a universal series bus (USB) port and a series peripheral interface bus (SPI) port which are used to connect to a communication device and an electrical device respectively. The communication device stores a BIOS updating data and includes USB port. The electrical device includes a motherboard, a SPI port and a BIOS chip. The SPI port is electrically connected to the motherboard. The BIOS chip is electrically connected to the SPI port and stores a BIOS old data. The method includes the steps of making the bridge module connect to the communication device and the electrical device; and triggering updating process to make the communication device transmit the BIOS updating data to the electrical device through the bridge module to update the electrical device.

### FIELD OF THE INVENTION

The present invention relates to a bridge module for updating basic input/output system (BIOS) and an updating method thereof, and more particularly relates to a bridge module for updating BIOS, which has a universal series bus (USB) port and a series peripheral interface bus (SPI) port to be connected between a communication device and an electrical device for updating BIOS, and an updating method thereof.

### BACKGROUND OF THE INVENTION

Generally, as a computer is powered up, Basic Input/Output System (BIOS) will initialize the system hardware, test the function of the system hardware, and direct the executing of the operating system (OS). Attending with the growth of technology, updating frequency of software, hardware, or firmware has become faster and faster. For computer BIOS, various updating methods have been disclosed in the conventional art.

For example, Chinese patent publication No. 103455350 with the title of “an updating method for BIOS” has disclosed a BIOS updating method, and FIG. 1 is a schematic view showing the process of the conventional BIOS updating method. As shown, in the beginning, step S101 is carried out to power on the mother board, then, step S102 is executed to start up linux system of the Baseboard Management Controller (BMC), afterward, step S103 is carried out to load the updater and BIOS data, and finally, step S104 is executed to complete the updating of BIOS data.

According to the technology disclosed in this patent publication, it is noted that BMC circuits are broadly used for updating the BIOS, and thus should be included in the mother board of the electrical devices, such as PC, which may increase the fabrication cost. In addition, the updating process of the electrical device can only be executed in the power-on state, and thus, the operators needs an additional power-on step for executing the updating process, which may waste the operating time.

### BRIEF SUMMARY OF INVENTION

As mentioned, because the conventional BIOS updating method needs a BMC circuit for updating the BIOS and the updating method can only be executed in the power-on state, the fabrication cost would be increased and more operating time would be wasted for the updating process.

Accordingly, it is a main object of the present invention to provide a bridge module for updating BIOS and an updating thereof, which has the universal series bus (USB) port and the serial peripheral interface bus (SPI) port connected between the communication device and the electrical device such that the BMC circuit can be skipped and the updating process can be executed in the power-off state.

In view of the above mentioned object, a bridge module for updating basic input/output system (BIOS) is provided in accordance with the technology disclosed in the present invention. The bridge module for updating BIOS is utilized to electrically connect to a communication device and an electrical device for the communication device to update the electrical device. The communication device stores a BIOS updating data and includes a first universal series bus (USB) port, the electrical device includes a motherboard, a first serial peripheral interface bus (SPI) port, and a BIOS chip. The first SPI port is electrically connected to the motherboard. The BIOS chip is located on the motherboard and electrically connected to the first SPI port, and the BIOS chip also stores a BIOS old data. The bridge module for updating BIOS includes a second USB port, a processing unit, and a second SPI port. The second USB port is utilized for electrically connecting to the first USB port of the communication device, the processing unit is electrically connected to the second USB port, and the second SPI port is electrically connected to the processing unit.

When the electrical device is in a power-off state, the first USB port is electrically connected to the second USB port, the first SPI port is electrically connected to the second SPI port, and the communication device is triggered to execute a updating program, the communication device transmits a power signal from the first USB port and transmit a first updating signal including the BIOS updating data through the first USB port by using a USB packet format; the processing unit receives the power signal through the second USB port and transmits the power signal away, receives the first updating signal through the second USB port, and translates the USB packet format of the first updating signal into a SPI packet format so as to generate and transmit a second updating signal; the BIOS chip receives the power signal and the second updating signal through the first SPI port to have the BIOS updating data replacing the BIOS old data so as to update the BIOS chip.

In addition, an updating method for updating BIOS by using the bridge module mentioned above is also provided in accordance with the technology disclosed in the present invention, which is utilized for updating the electrical device when the electrical device is in the power-off state. Firstly, the first USB port is electrically connected to the second USB port, and the first SPI port is electrically connected to the second SPI port. Then, the communication device is triggered to execute the updating program so as to select the BIOS updating data. Afterward, the communication device transmits the power signal through the first USB port and the second USB port according to the selected BIOS updating data and transmits the first updating signal to the bridge module for updating BIOS by using the USB packet format. Then, the bridge module for updating BIOS receives the power signal and translates the USB packet format into the SPI packet format so as to translate the first updating signal into the second updating signal. Finally, the bridge module for updating BIOS transmits the power signal to the BIOS chip through the first SPI port and the second SPI port and transmits the second updating signal to the BIOS chip to have the BIOS updating data replacing the BIOS old data so as to update the BIOS chip.

According to a preferred embodiment of the bridge module for updating BIOS and the updating method thereof, the communication device may be a cell phone or a tablet computer, the electrical device may be a desktop computer, and the electrical device further comprises a power module electrically connected to the motherboard for supplying a power to the BIOS chip.

Because the bridge module for updating BIOS and the updating method provided in the present invention use the bridge module to replace the conventional BMC circuit, the motherboard provider does not need to concern the arrangement of BMC circuit and thus the fabrication cost can be reduced. In addition, because the bridge module is capable of transmitting the power from the communication device to the electrical device, the communication device may update BIOS of the electrical device even when the electrical device is in the power-off state and thus the updating time can be reduced.

The embodiments in the present invention would be further discussed by using the flowing paragraphs and figures for a better understanding.

### BRIEF DESCRIPTION OF THE DRAWINGS

FIG. 1 is a flowchart showing the process of a conventional BIOS updating method.

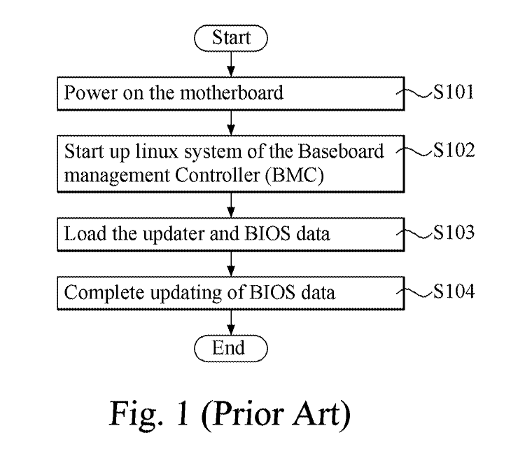

FIG. 2 is a block diagram showing a bridge module for updating BIOS in accordance with a preferred embodiment of the present invention.

FIG. 3 is a flowchart showing a BIOS updating method in accordance with a preferred embodiment of the present invention.

### DETAILED DESCRIPTION OF THE INVENTION

There are various embodiments of the bridge module for updating BIOS and the updating method thereof in accordance with the present invention, which are not repeated hereby. Only one preferred embodiments are mentioned in detail in the following paragraphs as an example. It should be understood by those skilled in the art that the preferred embodiments disclosed in the following paragraphs are merely an example instead of restricting the scope of the invention itself.

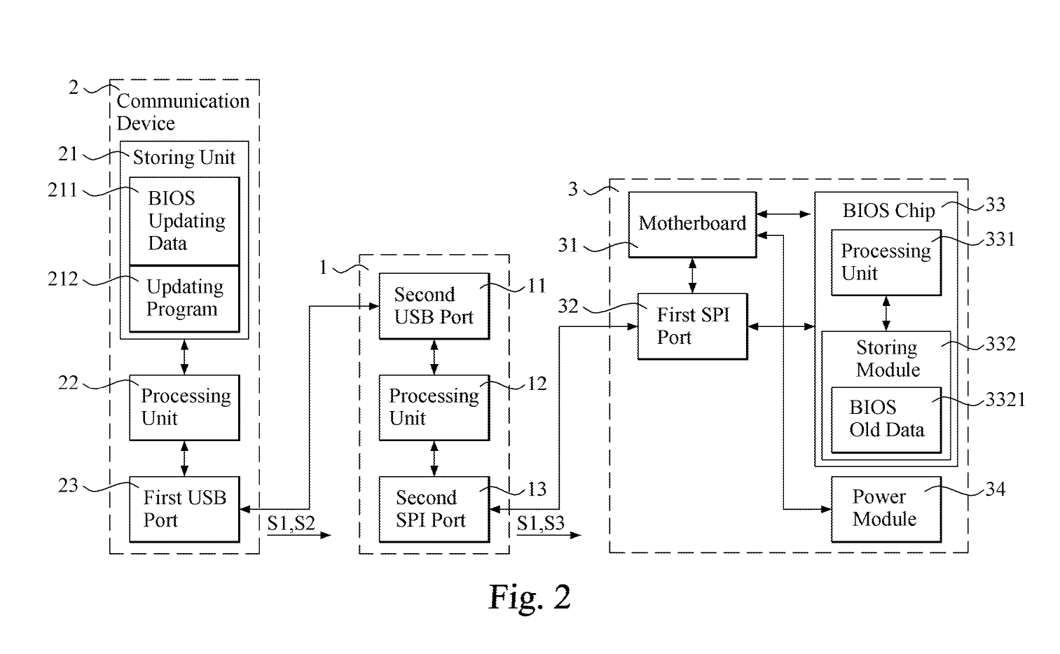

Please refer to FIG. 2, which is a block diagram showing a bridge module for updating BIOS in accordance with a preferred embodiment of the present invention. As shown, the bridge module 1 for updating basic input/output system (BIOS) provided in accordance with the present invention is utilized to connect to a communication device 2 and an electrical device 3. The communication device 2 is a cell phone or a tablet computer. However, the present invention is not so restricted. The other devices with wired or wireless communication function can also be used in the present invention. In the present embodiment, the communication device 2 is a cell phone.

The communication device 2 includes a storing unit 21, a processing unit 22, and a first universal series bus (USB) port 23, wherein the storing unit 21 stores at least a BIOS updating data 211. The BIOS updating data 211 may be downloaded from the cloud or wired transmitted from the other devices. The storing unit 21 may be an existing memory, which is well known and thus is not repeated here.

The processing unit 22 is electrically connected to the storing unit 21. The processing unit 22 may be an existing central processing unit (CPU) or other functional circuitries with signal processing function. The first USB port 23 is electrically connected to the processing unit 22. The first USB port 23 may be an interface supporting USB1.1, USB2.0, and USB3.0, which is decided according to the design in practice.

The electrical device 3 is a desktop computer. However, the present invention is not so restricted. The electrical device 3 includes a motherboard 31, a first serial peripheral interface bus (SPI) port 32, a BIOS chip 33, and a power module 34. The motherboard 31 may be the main board of the existing electrical devices. The first SPI port 32 is electrically connected to the motherboard 31. Concretely speaking, the first SPI port 32 may be arranged on the motherboard 31 or electrically connected to the motherboard 31 through a communication line, which may be decided according to the need in practice. The BIOS chip 33 may include a processing unit 331 and a storing module 332. The processing unit 331 and the storing module 332 are electrically connected with each other, wherein the processing unit 331 may be an ordinary processor, and the storing module 332 may be the existing memory, such as read-only memory (ROM), flash memory, etc. The power module 34 may be the existing power supply for providing power, which is electrically connected to the motherboard 31 for providing power to the BIOS chip 33.

The BIOS chip 33 is located on the motherboard 31 and electrically connected to the first SPI port 32 by the way of wired communication for example. The BIOS chip 33 stores at least a BIOS old data 3321. Precisely speaking, the BIOS old data 3321 is stored in the storing module 332. The BIOS old data 3321 is defined as the original file stored in the electrical device 3, which may be a corrupted file or an old version of file.

The bridge module 1 for updating BIOS includes a second USB port 11, a processing unit 12, and a second SPI port 13. The second USB port 11 is utilized for electrically connect to the first USB port 23 of the communication device 2, and the second USB port 11 may be also an interface of USB1.1, USB2.0 and USB3.0. The processing unit 12 may be an existing processor, which is not repeated here. The processing unit 12 is electrically connected to the second USB port 11 and the second SPI port 13.

It is noted that the bridge module 1 for updating BIOS may be assembled to the electrical device 3, or as a single isolated module, which is decided according to the need in practice. In the present embodiment, an isolated module is described as an example.

The present embodiment is executed as the electrical device 3 in the power-off state, which is defined as the condition that the motherboard 31 received the power from the electrically connected power module 34 but the electrical device 3 does not start up. In addition, in accordance with a preferred embodiment of the present invention, the communication device 2 has an application (APP), such as an updating program 212, stored in the storing unit 21.

In the condition that the electrical device 3 is in the power-off state, the first USB port 23 is electrically connected to the second USB port 11, the first SPI port 32 is electrically connected to the second SPI port 13, and the communication device 2 is triggered to execute the updating program 212, the communication device 2 will transmit a power signal S1 from the first USB port 23 and transmit a first updating signal S2 including the BIOS updating data 211 through the first USB port 23 by using a USB packet format.

The processing unit 12 of the bridge module 1 for updating BIOS receives the power signal S1 through the second USB port 11 and transmits the power signal S1 away, and the processing unit 12 also receives the first updating signal S2 through the second USB port 11 to translate the USB packet format of the first updating signal S2 into a SPI packet format to generate and transmit a second updating signal S3.

The BIOS chip 33 receives the power signal 51 and the second updating signal S3 through the first SPI port 32 to have the BIOS updating data 211 replacing the BIOS old data 3321 so as to update the BIOS chip 33.

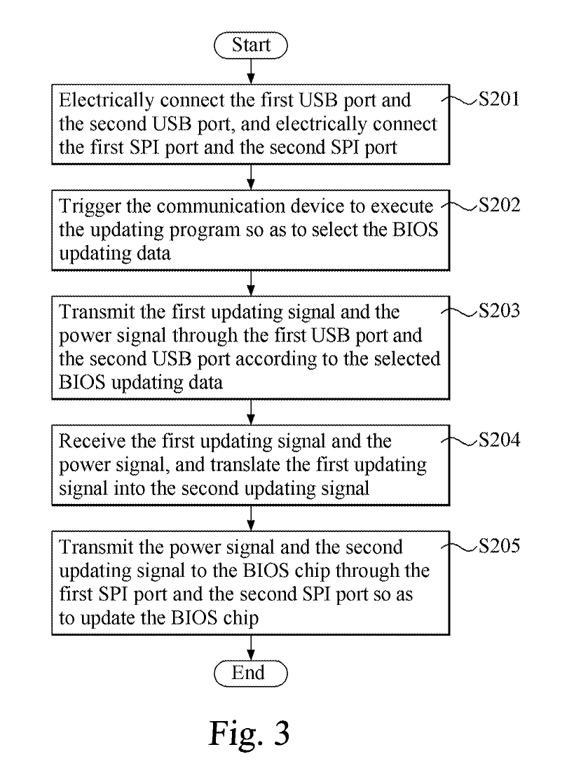

In order to clarify the operation of the present invention such that those skilled in the art can understand the spirit of the present invention, please refer to FIG. 3, which is a flowchart showing a BIOS updating method in accordance with a preferred embodiment of the present invention. As shown, an updating method for updating BIOS by using the bridge module mentioned above in accordance with the present invention comprises the steps of (please also refer to FIG. 2 for the labels):

S201: electrically connecting the first USB port and the second USB port, and electrically connecting the first SPI port and the second SPI port;

S202: triggering the communication device to execute the updating program so as to select the BIOS updating data;

S203: transmitting the first updating signal and the power signal through the first USB port and the second USB port according to the selected BIOS updating data;

S204: receiving the first updating signal and the power signal, and translating the first updating signal into the second updating signal; and

S205: transmitting the power signal and the second updating signal to the BIOS chip through the first SPI port and the second SPI port so as to update the BIOS chip.

The updating method for updating BIOS in accordance with the present embodiment is executed when the electrical device 3 is in the power-off state. However, the method can also be executed in the power-on state just with the circuitry of the motherboard 31 being modified. However, because the updating method for updating BIOS chip 33 in the power-on state is well known, it is not repeated here.

As the process starts, step S201 is executed to have the first and the second USB ports electrically connected with each other and have the first and the second SPI ports electrically connected with each other. The user may use the USB transmission line to electrically connect the first USB port 23 of the communication device 2 to the second USB port 11, and use the transmission line to electrically connect the first SPI port 32 of the electrical device 3 to the second SPI port 13 of the bridge module 1 for updating BIOS. However, the present invention is not so restricted. In the other embodiments, the method of wireless connection can be used.

After step S201, step S202 is executed to trigger the updating program so as to select the BIOS updating data. The user may start the updating program by touching the display (not shown) of the communication device 2 and select the wanted BIOS updating data 211 from the names of the plural BIOS updating files.

After step S202, step S203 is executed to transmit the first updating signal and the power signal through the first and the second USB ports according to the selected BIOS updating data. The processing unit 22 of the communication device 2 reads out the BIOS updating data 211 from the storing unit 21 according to the BIOS updating data 211 selected by the user, and transmits the first updating signal S2 including the BIOS updating data 211 through the first USB port 23 and the second USB port 11 to the bridge module 1 for updating BIOS by using the USB packet format, and also transmits the power signal S1 to the bridge module 1 for updating BIOS. In the present embodiment, the power signal S1 may be the power of the communication device 2, which is transmitted to the bridge module 1 for updating BIOS.

After step S203, step S204 is executed to receive the first updating signal and the power signal and translate the first updating signal into the second updating signal. The processing unit 12 of the bridge module 1 for updating BIOS not only receives the power signal S1, but also translates the USB packet format of the first updating signal S2 into the SPI packet format so as to translate the first updating signal S2 into the second updating signal S3.

After step S204, step S205 is executed to transmit the power signal and the second updating signal to the BIOS chip through the first and the second SPI ports to update the BIOS chip. The processing unit 12 of the bridge module 1 for updating BIOS transmits the power signal 51 to the BIOS chip 33 through the first SPI port 32 and the second SPI port 13 so as to provide electric power to the BIOS chip 33, and also transmits the second updating signal S3 to the BIOS chip 33 such that the processing unit 331 writes the BIOS updating data 211 into the storing module 332 to replace the BIOS old data 3321 so as to update the BIOS chip 33.

It should be noted that the purpose to have the power module 34 electrically connected to the motherboard 31 is to prevent the BIOS chip 33 from being disturbed by the other components or leaky current. The purpose to have the electrical power transmitted from the communication device 2 to the BIOS chip 33 of the electrical device 3 through the bridge module 1 for updating BIOS by using the power signal is to make sure the BIOS chip 33 can be identified as SPI slave and the BIOS chip 33 of the electrical device 3 can be updated in the power-off state.

In conclusion, the spirit of the present invention is to replace the BMC circuit by using the bridge module such that the motherboard provider does not need to take the arrangement of BMC circuit into concern and thus the fabrication cost can be reduced. In addition, because the bridge module is capable of transmitting the power from the communication device to the electrical device, the communication device may update BIOS of the electrical device even when the electrical device is in the power-off state and thus the updating time can be reduced.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A bridge module for updating basic input/output system (BIOS), utilized to electrically connect to a communication device and an electrical device, for the communication device to update the electrical device, wherein the communication device stores a BIOS updating data and includes a first universal series bus (USB) port, the electrical device includes a motherboard, a first serial peripheral interface bus (SPI) port, and a BIOS chip, the first SPI port is electrically connected to the motherboard, the BIOS chip is located on the motherboard and electrically connected to the first SPI port, and the BIOS chip also stores a BIOS old data, and the bridge module for updating BIOS comprising:
a second USB port, utilized for electrically connecting to the first USB port of the communication device;
a processing unit, electrically connected to the second USB port; and
a second SPI port, electrically connected to the processing unit;
wherein when the electrical device is in a power-off state, the first USB port is electrically connected to the second USB port, the first SPI port is electrically connected to the second SPI port, and the communication device is triggered to execute a updating program, the communication device transmits a power signal from the first USB port and transmit a first updating signal including the BIOS updating data through the first USB port by using a USB packet format; the processing unit receives the power signal through the second USB port and transmits the power signal away, receives the first updating signal through the second USB port, and translates the USB packet format of the first updating signal into a SPI packet format so as to generate and transmit a second updating signal; the BIOS chip receives the power signal and the second updating signal through the first SPI port to have the BIOS updating data replacing the BIOS old data so as to update the BIOS chip.

2. The bridge module for updating BIOS of claim 1, wherein the communication device is a cell phone or a tablet computer.

3. The bridge module for updating BIOS of claim 1, wherein the electrical device is a desktop computer.

4. The bridge module for updating BIOS of claim 1, wherein the electrical device further comprising a power module, electrically connected to the motherboard for supplying power to the BIOS chip.

5. A method for updating BIOS by using the bridge module of claim 1, which is utilized for updating the electrical device when the electrical device is in the power-off state, comprising the steps of:
(a) electrically connecting the first USB port to the second USB port, and electrically connecting the first SPI port to the second SPI port;
(b) triggering the communication device to execute the updating program so as to select the BIOS updating data;
(c) the communication device transmitting the power signal through the first USB port and the second USB port according to the selected BIOS updating data and transmitting the first updating signal to the bridge module for updating BIOS by using the USB packet format;
(d) the bridge module for updating BIOS receiving the power signal and translating the USB packet format into the SPI packet format so as to translate the first updating signal into the second updating signal;
(e) the bridge module for updating BIOS transmitting the power signal to the BIOS chip through the first SPI port and the second SPI port and transmitting the second updating signal to the BIOS chip to have the BIOS updating data replacing the BIOS old data so as to update the BIOS chip.

6. The method for updating BIOS of claim 5, wherein the communication device is a cell phone or a tablet computer.

7. The method for updating BIOS of claim 5, wherein the electrical device is a desktop computer.
